(19) United States
(12) Patent Application Publication
(10) Pub. No.: US 2016/0202830 A1
(43) Pub. Date: Jul. 14, 2016

(54) TOUCH SCREEN PANEL AND DRIVING METHOD THEREOF

(71) Applicant: Samsung Display Co., Ltd., Yongin-si (KR)

(72) Inventor: Ji-Gong LEE, Yongin-si (KR)

(21) Appl. No.: 14/878,614

(22) Filed: Oct. 8, 2015

(30) Foreign Application Priority Data
Jan. 13, 2015 (KR) 10-2015-0006354

(51) Int. Cl. G06F 3/041; G06F 3/044

(52) U.S. Cl. CPC G06F 3/0416; G06F 3/044

(57) ABSTRACT

A touch screen panel includes a display unit including a pixel unit and a timing controller, the display unit configured to implement an image by using the timing controller to receive a synchronization signal comprising a horizontal synchronization signal, wherein the timing controller is configured to control the generation of data signals, a touch panel, and a touch controller configured to generate and supply a driving signal to the touch panel in response to wirelessly receiving the horizontal synchronization signal from the display unit.

### CROSS-REFERENCE TO RELATED APPLICATION

This application claims priority from and the benefit of Korean Patent Application No. 10-2015-0006354, filed on Jan. 13, 2015, which is hereby incorporated by reference for all purposes as if fully set forth herein.

### BACKGROUND

1. Field

Exemplary embodiments relate to a touch screen panel, and a driving method of a touch screen panel.

2. Discussion of the Background

A touch screen panel is a device that displays an image through a display unit and recognizes a touch through a user's finger or another external object to receive a command from the user.

Since the touch screen panel is capable of replacing multiple input devices (e.g., a keyboard and a mouse), the uses of the touch screen have gradually expanded.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a touch screen panel that may wirelessly receive and transmit a synchronization signal and a driving method the touch screen panel.

Additional aspects will be set forth in the detailed description which follows, and, in part, will be apparent from the disclosure, or may be learned by practice of the inventive concept.

An exemplary embodiment discloses a touch screen panel that includes a display unit comprising a pixel unit and a timing controller, the display unit configured to implement an image by using the timing controller to receive a synchronization signal comprising a horizontal synchronization signal. The timing controller is configured to control the generation of data signals, a touch panel, and a touch controller configured to generate and supply a driving signal to the touch panel in response to wirelessly receiving the horizontal synchronization signal from the display unit.

An exemplary embodiment also discloses a method of driving a touch screen panel that includes supplying a synchronization signal corresponding to a horizontal synchronization signal to one or more lines formed on a display unit for a first porch period of a specific frame, receiving the horizontal synchronization signal at a touch controller by detecting a change in a voltage of a touch panel and a pixel unit of a display panel in response to the synchronization signal, and generating a driving signal supplied to the touch panel in response to the horizontal synchronization signal.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a diagram illustrating a touch screen panel according to an exemplary embodiment.

FIG. 2 is a diagram illustrating a touch panel according to the exemplary embodiment.

FIG. 3 is a waveform diagram illustrating a driving method according to an exemplary embodiment.

FIG. 4 is a diagram illustrating an enlarged a first porch period of FIG. 3.

FIG. 5 is a diagram illustrating an enlarged second porch period of FIG. 3.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

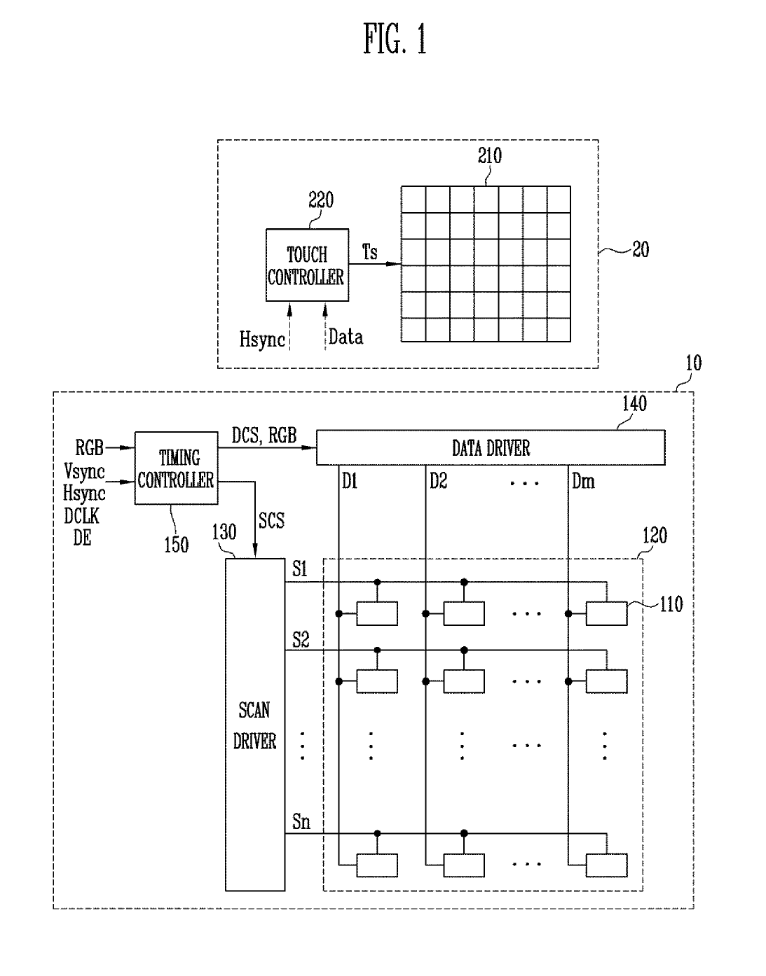

FIG. 1 is a diagram illustrating a touch screen panel according to an exemplary embodiment.

Referring to FIG. 1, the touch screen panel according to the exemplary embodiment includes a display unit 10 and a touch sensing unit 20.

The display unit 10 is a device for implementing an image. The display unit 10 may be implemented by an organic light emitting display device, a liquid crystal display, and the like. The display unit 10 may include a pixel unit 120, a scan driver 130, a data driver 140, and a timing controller 150.

The timing controller 150 may receive image data RGB and synchronization signals from an external system. Here, the synchronization signals may include a vertical synchronization signal Vsync, a horizontal synchronization signal Hsync, a dot clock DCLK, and a data enable signal DE.

The timing controller 150 receiving the synchronization signals Vsync, Hsync, DCLK, and DE generates a scan driving control signal SCS and a data driving control signal DCS. The scan driving control signal SCS generated by the timing controller 150 is supplied to the scan driver 130. The data driving control signal DCS generated by the controller 150 is supplied to the data driver 140. Further, the timing controller 150 realigns image data RGB for driving and supplies the realigned image data RGB to the data driver 140.

The scan driver 130 receiving the scan driving control signal SCS generates a scan signal. The scan driver 130 supplies the generated scan signal to scan lines S1 to Sn. For example, the scan driver 130 may sequentially supply the scan signal to the scan lines S1 to Sn.

The data driver 140 receiving the data driving control signal DCS generates a data signal. The data driver 140 generating the data signal supplies the data signal to data lines D1 to Dm to be synchronized with the scan signal supplied by the scan driver 140 to scan lines S1 to Sn.

The pixel unit 120 includes pixels 110 driven by the signals supplied through the scan lines S1 to Sn and the data line D1 to Dm.

The pixels 110 are selected in the unit of a horizontal line in response to the scan signal supplied through any one of the scan lines S1 to Sn. Each of the pixels 110 selected by the scan signal receives the data signal from any one of the data lines D1 to Dm connected to the pixel. Each of the pixels 110 receiving the data signal generates light with predetermined brightness in response to the data signal.

The touch sensing unit 20 detects a touch using a finger and/or an object. The touch sensing unit 20 includes a touch panel 210 and a touch controller 220.

The touch panel 210 may be a resistive type touch panel, a photosensitive type touch panel, and/or a capacitive type, touch panel. Regardless of the type, the touch panel 210 detects a touch using a finger and/or an object.

The touch controller 220 supplies a driving signal Ts to the touch panel 210. Here, the touch controller 220 wirelessly receives the horizontal synchronization signal Hsync and the data Data from the display unit 10. A method of wirelessly supplying the horizontal synchronization signal Hsync and the data Data from the display unit 10 will be described with a driving waveform below.

The touch controller 220 receiving the horizontal synchronization signal Hsync and the data Data generates a driving signal Ts at a different time from a supply time of the data signal so as to minimize a coupling noise.

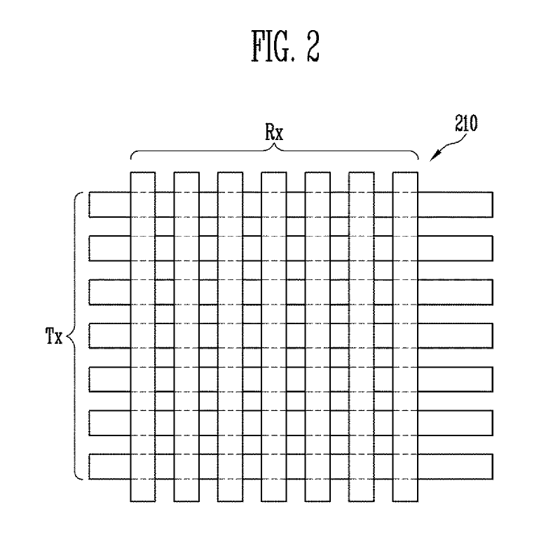

FIG. 2 is a diagram illustrating the touch panel according to the exemplary embodiment. For convenience of a description, FIG. 2 illustrates the touch panel 210 implemented as a capacitive type touch panel.

Referring to FIG. 2, the touch panel 210 includes driving electrodes Tx and sensing electrodes Rx formed in a direction crossing the driving electrodes Tx.

In an embodiment, the driving electrodes Tx and the sensing electrodes Rx are formed on a transparent substrate (not shown) and may be formed on different layers or the same layer. In an embodiment, the driving electrodes Tx and the sensing electrodes Rx may include different transparent conductive materials of the same transparent conductive materials. In an embodiment, the transparent conductive material may be indium tin oxide (ITO), indium zinc oxide (IZO), carbon nanotube (CNT), or graphene.

The driving electrodes Tx may sequentially receive the driving signal Ts from the touch controller 220.

The sensing electrodes Rx detect a variation in capacitance by a touch, and in response to the detected variation of capacitance the sensing electrodes Rx supply the detected variance to a driving circuit (not shown).

Here, the driving signal Ts is sequentially supplied to the driving electrodes Tx so that it is possible to determine a touch area in the touch panel 210 by using the sensing electrode Rx to detect a variance in capacitance.

Although FIG. 2 illustrates that the driving electrodes Tx and the sensing electrodes Rx arranged in an orthogonally crossing form, the driving electrodes Tx and the sensing electrodes Rx may be arranged in any form. In an embodiment, the driving electrodes Tx and the sensing electrodes Rx may be arranged in a geometrical crossing form (a concentric line and a radial line in a polar coordinates arrangement).

Although FIG. 2 illustrates that the driving electrodes Tx and the sensing electrodes Rx have bar shapes, the illustration is not intended to be limiting. The driving electrodes Tx and the sensing electrodes Rx may have any shape. In an embodiment, the driving electrodes Tx and the sensing electrodes Rx may be implemented as a diamond.

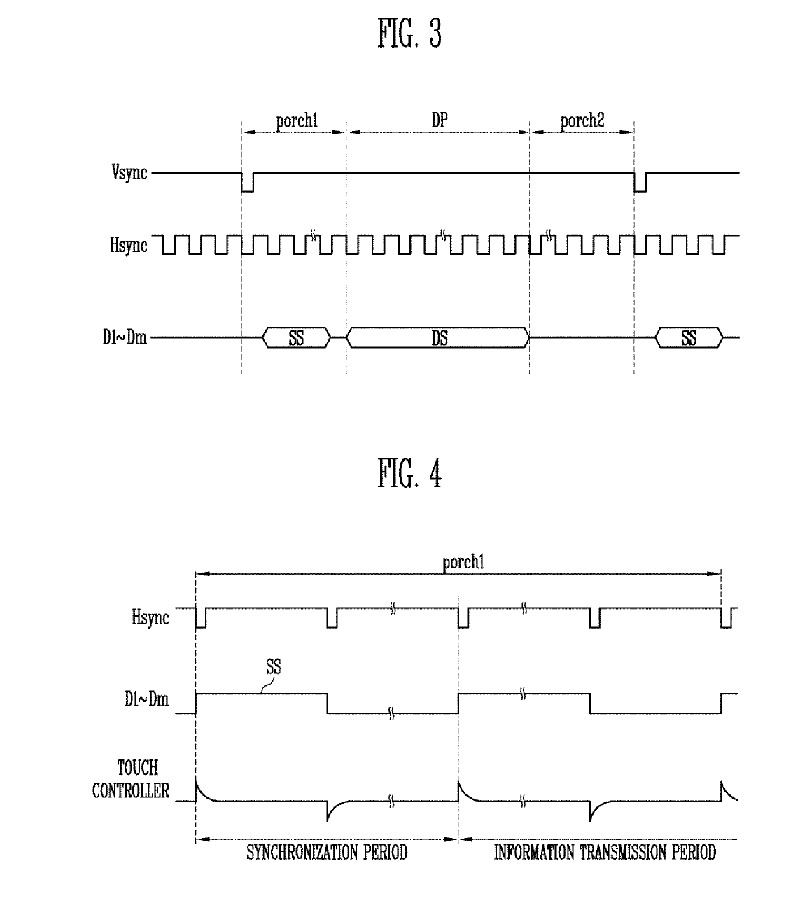

FIG. 3 is a waveform diagram illustrating a driving method according to an exemplary embodiment.

Referring to FIG. 3, the timing controller 150 may receive the vertical synchronization signal Vsync and the horizontal synchronization signal Hsync. Here, the vertical synchronization signal Vsync is used as a signal for dividing one screen (i.e., a signal for dividing a frame). The horizontal synchronization signal Hsync is used for driving a unit of a horizontal line. For example, the timing controller 150 of FIG. 1 may control the scan driver 130 so that the scan signal is supplied for every period of the horizontal synchronization signal Hsync.

One frame period divided by the vertical synchronization signal Vsync is divided into a data period DP, a first porch period Porch 1 positioned before the data period DP, and a second porch period Porch2 positioned after the data period DP.

The data period DP is a period for which the scan signal is supplied to the scan lines S1 to Sn and the data signal DS is supplied to the data lines D1 to Dm to be synchronized to the scan signal. Thus, each of the pixels 110 receives the data signal (DS) necessary for implementing an image for the data period (DP).

A porch period is positioned at a beginning part and the latter part of one frame period. The porch period is a period for stabilizing various signals (i.e., a data enabling signal).

In an embodiment, a synchronization signal SS repeated with a low voltage and a high voltage is supplied to one or more data lines D1 to Dm (e.g., all the data lines D1 to Dm), for at least a partial period of the first porch period Porch 1. Hereinafter, for convenience of the description, it is assumed that the synchronization signal SS is supplied to all of the data lines D1 to Dm.

In an embodiment, the data driver 140 supplies the synchronization signal SS repeated with a high voltage (e.g., a voltage corresponding to a black gray) and a low voltage (e.g., a voltage corresponding to a white gray) to the data lines D1 to Dm for the first porch period Porchl. Here, the synchronization signal SS is repeated with the high voltage and the low voltage based on the horizontal synchronization signal Hsync.

The touch controller 220 recognizes a period of the horizontal synchronization signal Hsync by using the synchronization signal SS supplied to the data lines D1 to Dm for the first porch period Porch 1.

Throughout this application it is described that the synchronization signal is supplied to the data lines D1 to Dm, but the present invention is not limited such an embodiment. In an exemplary embodiment, the synchronization signal may be supplied to various forms of lines formed on the display unit 10 and in which a voltage change is detectable in the touch panel 210.

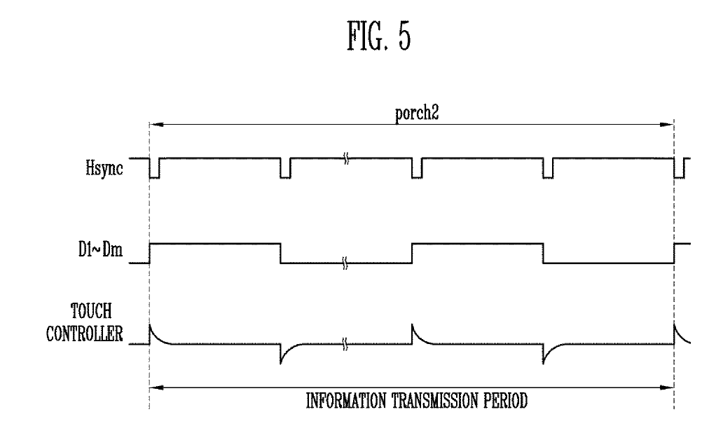

FIG. 4 is a diagram which the first porch period Porch 1 illustrated in FIG. 3 is enlarged according to an exemplary embodiment.

Referring to FIG. 4, the first porch period Porch 1 is divided into a synchronization period and an information transmission period.

The data driver 140 repeatedly supplies a high voltage and a low voltage to the data lines D1 to Dm based on the period of the horizontal synchronization signal Hsync. When the high voltage and the low voltage are repeatedly supplied to the data lines D1 to Dm, a high signal (a signal by a coupling noise) corresponding to the high voltage and a low signal corresponding to the low voltage is transmitted to the touch panel 210 by capacitance between the pixel unit 120 and the touch panel 210.

The touch controller 220 recognizes a period and a supply time of the horizontal synchronization signal Hsync in response to the high signal and the low signal of the touch panel 210. Thus, the touch controller 220 receives the horizontal synchronization signal Hsync. The touch controller 220 recognizing the period of the horizontal synchronization signal Hsync generates a driving signal Ts and supplies the generated driving signal Ts to the driving electrodes Tx at a different time from the supply time of the data signal.

The data driver 140 may supply the synchronization signal SS repeated with the high voltage and the low voltage to the data lines based on the period of the horizontal synchronization signal Hsync for the synchronization period, or supply the high voltage and the low voltage to a predetermined specific pattern (e.g., 110010101) as the synchronization signal SS. When the synchronization signal SS is supplied with the predetermined specific pattern, it is possible to prevent the period of the horizontal synchronization signal Hsync from being incorrectly recognized due to a noise and the like which may be inputted from the outside.

Further, the synchronization signal SS may be supplied to include a period information of the horizontal synchronization signal Hsync as the specific pattern. For example, when the period of the horizontal synchronization signal Hsync corresponds to an amount (e.g., 500) of an internal counter of the touch controller 220, a specific pattern (e.g., 111110100) corresponding to that amount (e.g., 500) may be supplied as the synchronization signal (SS).

For the information transmission period, the data driver 140 supplies an information signal including specific information to the data lines D1 to Dm based on the period of the horizontal synchronization signal Hsync. For example, the data driver 140 may supply an information signal indicating a start of the data period DP with a specific pattern (i.e., 11100011). Then, the touch controller 220 receiving the information signal recognizes that the data period DP starts, and supplies a driving signal Ts to the driving electrodes Tx in response to the data period DP. In addition, the information signal may additionally include various information including display resolution and the like.

As described above, various information, including the period of the horizontal synchronization signal Hsync, may be wirelessly transmitted from the display unit 10 to the touch sensing unit 20 without a separate line. Thus, in an embodiment, information may be transmitted by using capacitance between the display unit 10 and the touch sensing unit 20. Accordingly, a separate line, pin, connector, and the like may be removed between the display unit 10 and the touch sensing unit 20.

FIG. 5 is a diagram of an exemplary embodiment in which the second porch period Porch2 illustrated in FIG. 3 is enlarged.

Referring to FIG. 5, the second porch period Porch2 includes an information transmission period.

During the information transmission period, the data driver 140 supplies an information signal including specific information to the data lines D1 to Dm based on the period of the horizontal synchronization signal Hsync. For example, the data driver 140 may supply an information signal indicating an end of the data period DP to the data lines D1 to Dm with a predetermined pattern (e.g., a high voltage and a low voltage are supplied to the data lines D1 to Dm in response to the predetermined pattern). The touch controller 220 receiving the information signal recognizes that the data period DP is ended, and thus stops the supply of the driving signal Ts. In addition, various information desired for transmission may be included in the information signal.

After the first porch period Porch 1 and the second porch period Porch2, the touch controller 220 may recognize the period of the horizontal synchronization signal Hsync, a time of the data period DP, and the like. Accordingly, the touch controller 220 drives the touch panel 210 in response to the recognized period of the horizontal synchronization signal Hsync, the recognized time of the data period DP, and the like. Further, when the first porch period Porchl and the second porch period Porch2 aforementioned with reference to FIGS. 4 and 5 are included for the two continuous frame periods, the touch controller may also additionally recognize a period of the vertical synchronization signal Vsync.

The first porch period Porch 1 and the second porch period Porch2 described with reference to FIGS. 4 and 5 may be included for every one or more frames (e.g., for every multiple frame periods). When the first porch period Porch 1 and the second porch period Porch2 are included for every multiple frame periods, the touch controller 220 may stably recognize the period of the horizontal synchronization signal Hsync, a time of the data period DP, and the like.

Throughout the application, the driving signal Ts generated by the touch controller 220 is described as being supplied for the data period DP, but the present invention is not limited thereto. In an embodiment, the touch controller 220 may supply the driving signal Ts for at least one period of the first porch period Porch 1 and the second porch period Porch2. The period for which the driving signal Ts is supplied does not overlap the synchronization period and the information transmission period.

By way of summation and review, a touch screen panel includes a display unit and a touch sensing unit. The display unit implements a predetermined image. The touch sensing unit detects a touch using a finger or an external object. Here, the touch sensing unit may be a resistive type touch sensing unit, a photosensitive type touch sensing unit, and a capacitive type touch sensing unit.

The display unit uses a scan signal and a data signal for implementing an image. Here, a predetermined noise is generated in response to a voltage change in a supply section of the scan signal and the data signal of the display unit. The generated noise is transmitted to the touch sensing unit. Accordingly, the touch sensing unit controls a driving signal so that touch driving is not performed at a section in which voltages of the scan signal and the data signal are changed. In addition, in order to recognize the section in which the voltages of the scan signal and the data signal are changed, a touch driver receives a horizontal synchronization signal from the display unit.

For example, predetermined pins are formed in the display unit and the touch driver, and the display unit and the touch driver may transmit and receive the horizontal synchronization signal by using the pins. However, when the horizontal synchronization signal is transmitted by using the pins, a separate communication protocol is used, thereby degrading versatility. Further, when the pins are formed, lines corresponding to the pins, separate connectors connected with the pins, and the like need to be added.

According to the touch screen panel according to the exemplary embodiment and the driving method the touch screen panel, it is possible to wirelessly transmit the horizontal synchronization signal of the display unit to the touch sensing unit. Thus, it is possible to transmit information including the horizontal synchronization signal by using capacitance between the display unit and the touch sensing unit, thereby removing lines, pins, connectors, and the like.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A touch screen panel, comprising:
a display unit comprising a pixel unit and a timing controller, the display unit configured to implement an image by using the timing controller to receive a synchronization signal comprising a horizontal synchronization signal, wherein the timing controller is configured to control the generation of data signals;
a touch panel; and
a touch controller configured to generate and supply a driving signal to the touch panel in response to wirelessly receiving the horizontal synchronization signal from the display unit.

2. The touch screen panel of claim 1, wherein the display unit further comprises:
a data driver for generating data signals and a scan driver for generating scan signals, wherein the pixel unit receives data signals and scan signals during a data period,
and a first porch period positioned before the data period and a second porch period positioned after the data period,
the data driver is configured to supply a synchronization signal corresponding to the horizontal synchronization signal to one or more data lines for a synchronization period that is a partial period of the first porch period.

3. The touch screen panel of claim 2, wherein the data driver is configured to supply a repeated high voltage and a low voltage based on the horizontal synchronization signal as the synchronization signal.

4. The touch screen panel of claim 2, wherein:
the horizontal synchronization signal is transmitted from the display unit a touch controller of the touch panel via capacitance between the touch panel and the pixel unit, the touch controller receives the horizontal synchronization signal based on a change in voltage.

5. The touch screen panel of claim 2, wherein the data driver is configured to supply a high voltage and a low voltage to the data lines in a specific pattern comprising period information about the horizontal synchronization signal.

6. The touch screen panel of claim 2, wherein the data driver is configured to supply a high voltage and a low voltage to the data lines in a specific pattern for an information transmission period, but not for the synchronization period of the first porch period.

7. The touch screen panel of claim 6, wherein the specific pattern comprises start information about the data period.

8. The touch screen panel of claim 2, wherein the data driver is configured to supply a high voltage and a low voltage to data lines in a specific pattern for the second porch period.

9. The touch screen panel of claim 8, wherein the specific pattern comprises end information about the data period.

10. A method of driving a touch screen panel, comprising:
supplying a synchronization signal corresponding to a horizontal synchronization signal to one or more lines formed on a display unit for a first porch period of a specific frame;
receiving the horizontal synchronization signal at a touch controller by detecting a change in a voltage of a touch panel and a pixel unit of a display panel in response to the synchronization signal; and
generating a driving signal supplied to the touch panel in response to the horizontal synchronization signal.

11. The method of claim 10, wherein the synchronization signal is supplied to one or more data lines formed in the display unit.

12. The method of claim 10, wherein the synchronization signal is a repeated signal of a high voltage and a low voltage based on the horizontal synchronization signal.

13. The method of claim 10, wherein
a high voltage and a low voltage are supplied in a specific pattern to the one or more data lines for an information transmission period.

14. The method of claim 13, wherein the specific pattern comprises start information about a data period during which a scan signal is supplied to a signal line and a data signal is supplied to a data line.

15. The method of claim 10, wherein a high voltage and a low voltage are supplied to the one or more data lines in a specific pattern for a second porch period occurring at a latter part of the specific frame.

16. The method of claim 15, wherein the specific pattern includes end information about a data period, the data period occurring after the first porch period and before the second porch period of the specific frame period for which a scan signal and a data signal are supplied.

17. The method of claim 10, the synchronization signal is wirelessly transmitted to the touch panel via a capacitance difference between the display unit and the touch panel.
